(19) United States
(12) Patent Application Publication
(10) Pub. No.: US 2006/0098082 A1
(43) Pub. Date: May 11, 2006

(54) Thermal paper, and method and apparatus for manufacturing the same

(75) Inventors: Chiaki Tanuma, Kanagawa (JP); Toshiyuki Tamura, Shizuoka (JP); Takayuki Hiyoshi, Shizuoka (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Toshiba Tec Kabushiki Kaisha, Tokyo (JP)

(21) Appl. No.: 11/245,608

(22) Filed: Oct. 6, 2005

(30) Foreign Application Priority Data
Nov. 10, 2004 (JP) 2004-326419

(51) Int. Cl. B41M 3/12; B41J 2/325

(52) U.S. Cl. 347/216; 427/148

(57) ABSTRACT

A method is provided for manufacturing a thermal paper from a thermal recording medium having a thermal color developing layer on a recording surface thereof. The method includes developing at least one color on one portion of the thermal color developing layer, and cutting off a portion of the thermal recording medium at the one portion.

### CROSS REFERENCE TO RELATED APPLICATION

The present application is based on and claims the benefit of priority of Japanese Patent Application P2004-326419 filed on Nov. 10, 2004, the entire contents of which are incorporated herein by reference.

### BACKGROUND OF THE INVENTION

1. Field of the Invention

The present invention relates to a thermal paper, and to a method and an apparatus for manufacturing the thermal paper.

2. Description of the Related Art

A thermal paper is formed by laminating a thermal color developing layer on a surface of a base sheet. To print on the thermal paper, a heating element of a printing head contacts with the thermal paper, and the heating element is heated to develop a color on the thermal color developing layer so that desired characters and figures are printed on the thermal color developing layer.

As a method for forming the thermal color developing layer on the base sheet, coating apparatuses such as a blade coater, an air knife coater, a roll coater, a bar coater, a gravure coater, a lip coater, and so on can be used to coat thermal ink on the base sheet. As the base sheet, a rolled paper that is one meter in width and several thousand meters in length, or a large-sized sheet can be used. A thermal recording medium including the thermal recording layer on the base sheet is cut by a slitter or a cutter into a small rolled thermal recording medium having a desired width and length, or into a thermal paper such as a thermal label.

As an example, an apparatus for manufacturing a thermal paper using the rolled thermal recording medium includes a conveyer for pulling out and conveying the rolled thermal recording medium which is set in the apparatus, a printing head for printing on the thermal recording medium by contacting and heating the unrolled thermal recording medium to develop a color, and a cutter for cutting the unrolled thermal recording medium into a desired length after printing based on printing data is executed (for example, see Japanese Laid-Open Publication No. 2001-180060, and Japanese Laid-Open Publication No. 2002-103286).

Before a color is developed thereon by the printing head, both sides of the thermal recording medium are white. When the thermal recording medium is heated by the printing head, the medium develops a color, for example in black, red, or blue, according to an ingredient such as a color fixing agent contained in the thermal recording medium. Further, there is a thermal recording medium having a plurality of areas on the base sheet which develop different colors.

When the thermal recording medium set in the apparatus for manufacturing the thermal paper is cut, a part of the thermal color developing layer may come off and fine powder such as color pigments may be produced. When the base sheet is paper, for example, more of the fine powder may be produced.

Fine powder that adheres to the cut thermal recording medium is conveyed with the thermal recording medium and may adhere to other places. When the fine powder adheres to a cutter, the cutter is susceptible to be nicked, and durability of the cutter is reduced. In addition, when the fine powder adheres to the printing head, the fine powder may act as abrasive powder between the printing head and the thermal recording medium and may thereby damage a protective layer of the printing head, and durability of the printing head is reduced.

As another problem, when the thermal recording medium having a thermal color developing layer which develops various colors is used, it is difficult to identify which color the thermal recording medium will develop before color development, since the thermal recording medium is white and almost transparent. Thus, when the thermal recording medium is printed on with the printing head, it is inconvenient that which color the thermal color developing layer would develop cannot be known in advance. In particular, since a thermal recording medium having a color developing area in a plurality of colors is white and almost transparent before a color development, a position of the color developing area and a color that would be developed on the thermal recording medium inconveniently cannot be identified in advance. A test printing may thus be necessary.

### SUMMARY OF THE INVENTION

An object of the present invention is to prevent an occurrence of fine powder which is generated by cutting a thermal recording medium, and thereby to prevent a cutter and a printing head provided in an apparatus for manufacturing a thermal paper from deteriorating.

According to the present invention, a method for manufacturing a thermal paper from a thermal recording medium having a thermal color developing layer on a recording surface thereof is provided which includes: (i) developing at least one color on one portion of the thermal color developing layer, and (ii) cutting off a portion of the thermal recording medium at the one portion.

According to the present invention, a thermal paper formed from a thermal recording medium is provided which includes: (i) a base sheet including a cutting plane at an edge thereof, and a recording surface on one surface thereof, (ii) a thermal color developing layer which is laminated on the recording surface and which includes a cutting plane that forms a continuous plane with the cutting plane of the base sheet, and (iii) a color developing area which is formed by heating the thermal color developing layer in an area that includes the cutting plane of the thermal color developing layer.

According to the present invention, an apparatus for manufacturing a thermal paper from a thermal recording medium having a thermal color developing layer on a recording surface thereof is provided, which develops a color on one portion of the thermal color developing layer, and which cuts off a portion of the thermal recording medium at the one portion.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a perspective view showing an appearance of an apparatus for manufacturing a thermal paper of an embodiment of the present invention;

FIG. 2 is a side view showing an inner structure of the apparatus for manufacturing the thermal paper;

FIG. 3 is a block diagram showing an electrical connection of the apparatus for manufacturing the thermal paper;

FIG. 4 is a flow chart illustrating steps of cutting off a printed thermal recording medium in the apparatus for manufacturing the thermal paper;

FIG. 5 is a plan view showing a large-sized thermal recording medium and a thermal label manufactured by cutting off the thermal recording medium;

FIG. 6 is a perspective view showing a rolled thermal recording medium;

FIG. 7 is a cross-sectional frame format showing a color developed area and non-color developed area of the thermal recording medium;

FIG. 8 is an illustration showing an experimental result as to how much an occurrence of fine powder is different in a case of cutting off a color developed area and in a case of cutting off a non color developed area of the thermal recording medium; and

FIG. 9 is a flow chart illustrating steps of printing on and cutting off the thermal recording medium, and developing a color on a cut portion of the thermal recording medium.

### DETAILED DESCRIPTION OF THE PREFERRED EMBODIMENTS

The first embodiment of the present invention will be described with reference to the drawings.

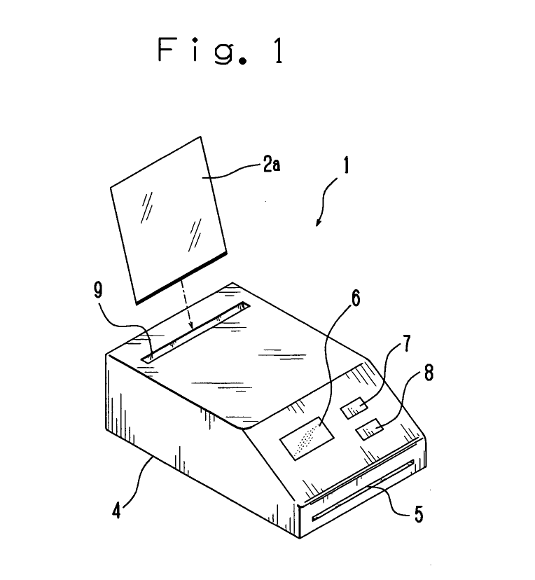

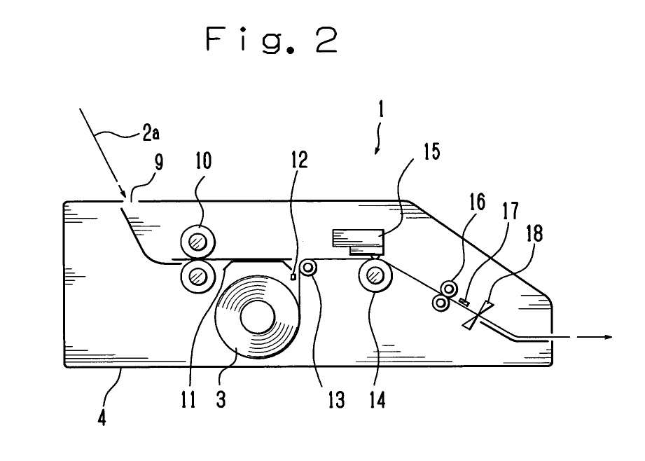

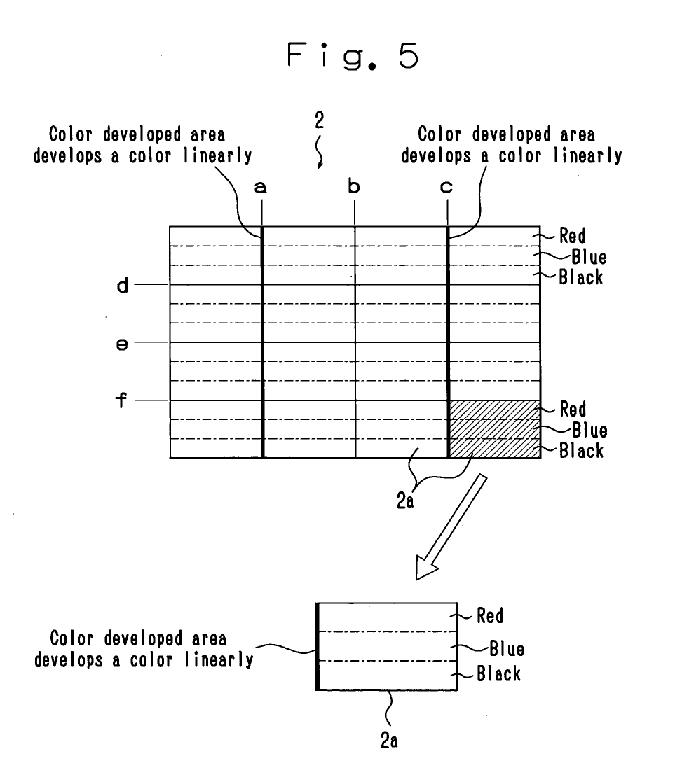

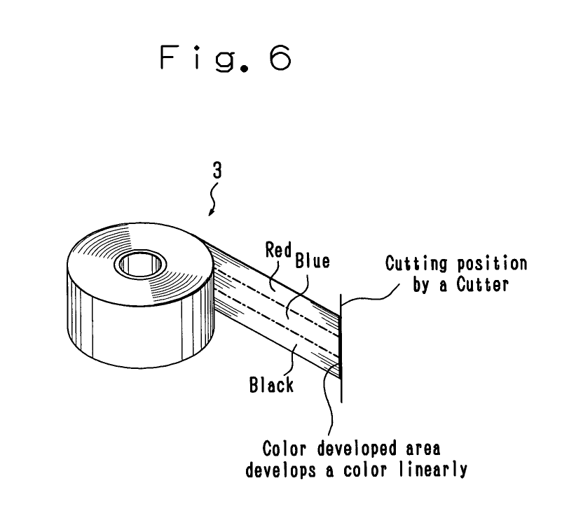

FIG. 1 is a perspective view showing an appearance of an apparatus for manufacturing a thermal paper by using a thermal recording medium. This apparatus 1 utilizes the thermal paper such as a thermal label 2a, which is produced by cutting off a rectangular shape from a large-sized thermal recording medium 2 (see FIG. 5). This apparatus 1 has a structure capable of using a rolled thermal recording medium 3 (see FIG. 2 and FIG. 6). A body case 4 of the apparatus 1 includes a delivery port 5 where the printed thermal label 2a or the rolled thermal recording medium 3 is expelled, an indicator 6 for displaying printing data for the printed thermal label 2a or the rolled thermal recording medium 3, a power button 7, and a cutter switch 8, which are provided at the front side thereof. An insertion slot 9 where the thermal label 2a is inserted is provided in the top surface of the body case 4.

FIG. 2 is a side view showing an inner structure of the apparatus 1 for manufacturing the thermal paper. Conveyance rollers 10, a guiding plate 11, a sensor 12, a guiding roller 13, a platen roller 14, a printing head 15, conveyance rollers 16, a sensor 17, and a cutter 18 are deployed in the body case 4 along a path from the insertion slot 9 to the delivery port 5. A thermal printer head can be used as the printing head 15. The rolled thermal recording medium 3 is detachably stored under the guiding plate 11 in the body case 4.

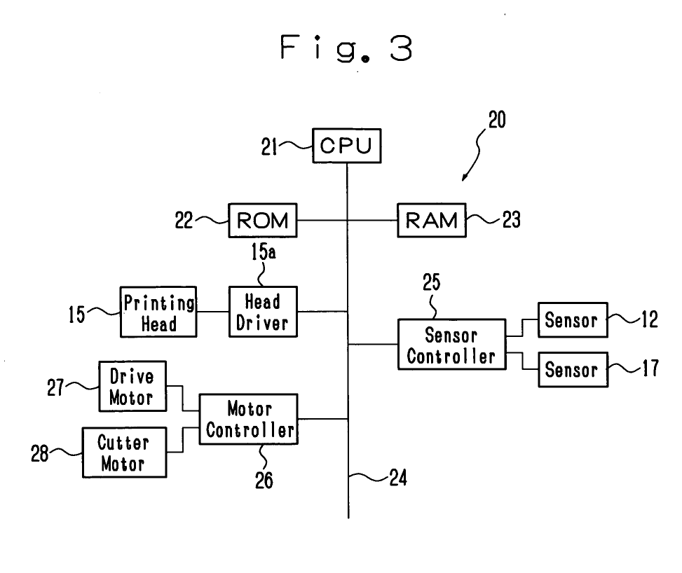

The conveyance rollers 10 are connected to a drive motor 27 (see FIG. 3) to be driven rotatably. The thermal label 2a inserted through the insertion slot 9 is conveyed on an upper surface of the guiding plate 11 by the rotatably driven conveyance roller, and is conveyed toward the printing head 15, which is positioned downstream of the conveyance rollers 10 in the conveying direction.

The sensor 12 is a reflection type sensor including a light emitting element and a light receiving element. A light emitted from the light emitting element shines on the unrolled thermal recording medium 3 and a light reflected from the unrolled thermal recording medium 3 is received by the light receiving element so that the thermal recording medium 3 is detected.

The guiding roller 13 is rotatably held to the body case 4 to guide the unrolled thermal recording medium 3 to the printing head 15 so that the unrolled thermal recording medium 3 is bent at the guiding roller 13 and conveyed towards the printing head 15.

The platen roller 14 is connected to the drive motor 27 to be driven rotatably and functions as a conveying part. As the platen roller 14 is driven rotatably, the thermal label 2a or the unrolled thermal recording medium 3 is conveyed toward the delivery port 5 positioned downstream in the conveying direction.

The printing head 15 is held by a head transfer mechanism (not shown) to be deployable to be able to contact an outer surface of the platen roller 14. A plurality of heating elements is arranged on the surface of the printing head 15, and the heating elements are heated selectively based on printing data. When the thermal label 2a or the unrolled thermal recording medium 3 is pinched between the platen roller 14 and the printing head 15, the heating elements of the printing head 15 are heated selectively, such that a part of the thermal label 2a or the unrolled thermal recording medium 3 which contacts the heating elements develops a color to thereby execute printing according to printing data.

The conveyance rollers 16 are connected to the drive motor 27 to be driven rotatably and function as a conveying part. As the conveyance rollers 16 are driven rotatably, the thermal label 2a or the unrolled thermal recording medium 3 is conveyed toward the delivery port 5 positioned downstream in the conveying direction.

The sensor 17 contains a light emitting element and a light receiving element, and is similar to the sensor 12. A light emitted from the light emitting element shines on the unrolled thermal recording medium 3 or the thermal label 2a, and a light reflected back from the unrolled thermal recording medium 3 or the thermal label 2a is received by the light receiving element so that the thermal recording medium 3 or the thermal label 2a is detected.

The cutter 18 has a pair of blades which are positioned opposite to each other. The blades move as the cutter motor 28 (see FIG. 3) is driven, to cut off a portion of the unrolled thermal recording medium 3. The cutting by the cutter 18 is executed after the thermal recording medium 3 is conveyed for a predetermined distance, in accordance with a press of the cutter button 8. A cut off portion of the thermal recording medium 3 is expelled from the delivery port 5 as a thermal paper 2a.

FIG. 3 is a block diagram showing an electrical connection of the apparatus 1. The apparatus 1 includes a controller 20 for controlling each part, and the controller 20 includes CPU (Central Processing Unit) 21 for executing various operations and so on, ROM (Read Only Memory) 22 for storing fixed data, various programs for the operations executed by the CPU 21, and so on, and RAM (Random Access Memory) 23 for functioning as a work area of the CPU 21.

The sensors 12 and 17 are connected to the CPU 21 through a sensor controller 25 via the bus line 24; the printing head 15 is connected to the CPU 21 through a head driver 15a via the bus line 24; and the drive motor 27 and the cutter motor 28 are connected to the CPU 21 through a motor driver 26 via the bus line 24. The drive motor 27 is a stepping motor for rotatably driving the conveyance rollers 10 and 16, and the platen roller 14. The apparatus 1 also includes terminals such as a cable terminal or a connector terminal (not shown), an optical communication section, and so on, and is connected to a keyboard or an external apparatus such as a personal computer through these terminals so that information such as the printing data can be given to the apparatus 1.

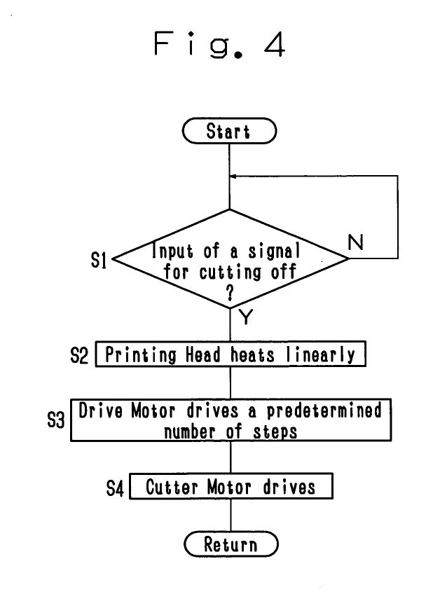

FIG. 4 is a flow chart illustrating steps of cutting off a printed thermal recording medium 3 linearly in the across-the-width direction. In the apparatus 1, a printing operation on the thermal recording medium 3 is executed by heating the printing head 15, and during the operation, it is judged whether a signal for cutting the thermal recording medium 3 is input or not (step S1).

When the signal for cutting the thermal recording medium 3 is input (Y of step S1), the printing head 15 heats the thermal recording medium 3 linearly in the across-the-width direction, and the thermal recording medium 3 develops a color linearly in the across-the-width direction. Thus a technique for developing a color linearly on the thermal recording medium 3 in the across-the-width direction is executed.

After the thermal recording medium 3 develops a color linearly in the across-the-width direction, the drive motor 27 drives a predetermined number of steps (step S3), and a color developed area of the thermal recording medium 3 is conveyed to a cutting position at the cutter 18. A technique for conveying the color developed area of the thermal recording medium 3 to the cutting position by the cutter 18 is thus executed.

The cutter motor 28 drives (step S4) after the drive motor 27 drives a predetermined number of steps at step S3, and the linear color developed area of the thermal recording medium 3 is cut by the cutter 18. A technique for cutting the linear color developed area of the thermal recording medium 3 by the cutter 18 is thus executed. Although the above example is a case of cutting off the thermal recording medium linearly, when the cutting portion is curved, for example, cutting can be executed along the curved line of the cutting portion.

FIG. 5 is a plan view showing a large-sized thermal recording medium 2 and a thermal label 2a, which is a thermal paper produced by cutting off a portion of the thermal recording medium 2. As shown in FIG. 5, one large-sized thermal recording medium 2 is cut into sixteen thermal labels 2a along section lines a to f. A striped area where colors are developed in red, blue and black is formed on a recording surface of the thermal recording medium 2, and each thermal label 2a is cut off in such a manner that those three colors (red, blue and black) lay out in the same way.

The thermal recording medium 2 is manufactured by laminating thermal color developing layers onto a base sheet. As the base sheet, for example, plastic films such as polyethylene, polyamide, polyester, polypropylene, polyvinyl chloride, or polyethylene terephthalate (PET) can be used. Quality paper or Japanese paper can also be used. As the color fixing agent, leuco dyes such as triphenylmethane dye, fluorine dye, or phenothiazine dye can be used. As the developer, phenol, an organic acid, or a solid acid can be used. As the coupling agent, water-soluble coupling agents such as a polyvinyl alcohol, a cellulose derivative, an aqueous acrylic resin, a starch derivative, or non-water-soluble coupling agents such as a polystyrene, or a polyvinyl chloride-vinyl acetate copolymer can be used.

In a process of manufacturing the thermal label 2a by cutting the thermal recording medium 2, the section lines a and c are heated by a thermal head (not shown) to develop a color linearly. Then, the portions of the thermal recording medium 2 are cut off at the linear color developed areas (which include the section lines a and c) to produce the thermal labels 2a.

In this case, a width of a predetermined color developing area is set to an area which includes a cutting portion in a non-printing area, and the area is close to a cutting position after the color is developed. Also, the width is set to be a requisite minimum length, which is based on a margin of errors of the cutting position.

Further, if the cutting portion is curved, the color development is executed along a curved shape of the cutting portion. A certain amount of effectiveness can be achieved even if only a main part of the cutting area develops a color due to a limitation of a printing condition, although it is desirable to develop a color on the whole area of the cutting portion.

Edges of each thermal label 2a develop a color. Since the edges of each thermal label 2a should be at least one portion of the non-printing area, there is no practical adverse effect even if the edges already developed colors in normal use.

When one edge of the thermal label 2a develops colors, since the color developing area having the edge includes an area where the three colors are developed, it can be known in advance which part of the area will develop which color. Thus, it is possible to confirm easily the correct direction of insertion of the thermal label 2a into the insertion slot 9.

In addition, by heating the cutting lines a and c on one portion of the thermal recording medium 2 to develop a color, adhesiveness between the thermal color developing layer and the base sheet forming the thermal recording medium 2 becomes stronger, and pigments near a surface of the thermal color developing layer are taken into the thermal color developing layer. Consequently, an occurrence of fine powder of the pigments can be inhibited when the color developed cutting lines a and c are cut. Additionally, in the process of manufacturing the thermal label 2a by cutting the thermal recording medium 2, it is preferable to heat all the cutting lines a to f to develop a color in order to further reduce the occurrence of fine powder.

In this case, in the embodiment of the present invention, by heating the one portion (not shown) by the thermal head, it becomes possible to improve the adhesiveness between the base sheet and the color developing areas more effectively, because the thermal head heats the thermal recording medium under pressure in normal use.

Further, various inconveniences due to the occurrence of fine powder can be prevented by developing a color on the cutting portion of the thermal recording medium 2, and by cutting the color developed portion so as to inhibit the occurrence of fine powder. The inconveniences of the fine powder might reduce the quality of a product image because the fine powder clings to the product and/or to the cutter used for cutting the thermal recording medium 2. Due to usage of the cutter when the fine powder adheres thereto, the cutter blade is susceptible to be nicked, and durability of the cutter is reduced.

FIG. 6 is a perspective view showing the rolled thermal recording medium 3. Similar to the thermal recording medium 2 explained in FIG. 5, a striped area which develops colors in red, blue and black is formed on a recording surface of the thermal recording medium 3. When the thermal recording medium 3 is set in the apparatus 1, printing on the unrolled thermal recording medium 3 is executed based on printing data, and after the printing, a portion of the thermal recording medium 3 is cut off by the cutter 18 and expelled from the apparatus 1 as a thermal paper 2a. An area to be cut by the cutter 18 has a color developed thereon linearly in the across-the-width direction of the thermal recording medium 3.

Thus, when the thermal recording medium 3 in use is removed from the apparatus 1, and then put back in the apparatus 1, it can be confirmed easily which color the thermal recording medium 3 will develop.

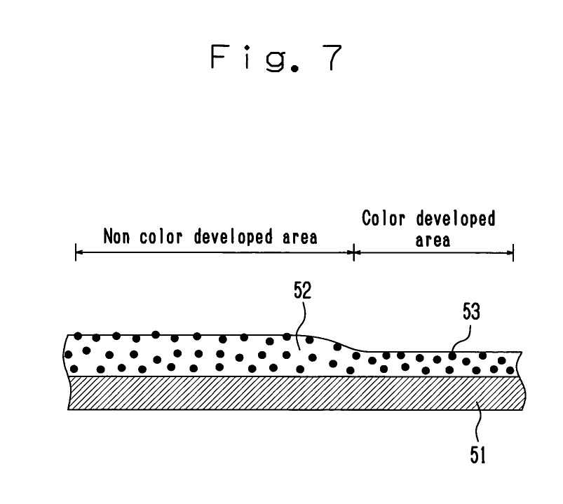

FIG. 7 is a cross-sectional frame format showing a heating area and a non-heating area of the thermal recording medium 3. By heating to develop a color on the area to be cut by the cutter 18, as shown in FIG. 7, adhesiveness between the thermal color developing layers 52 and the base sheet 51, which form the thermal recording medium 3, becomes stronger. Then, the pigments 53 which are near the surface of the thermal color developing layers 52 are taken into the thermal color developing layer 52 so that the occurrence of fine powder of the pigments 53 can be inhibited, even if the color developed area is cut.

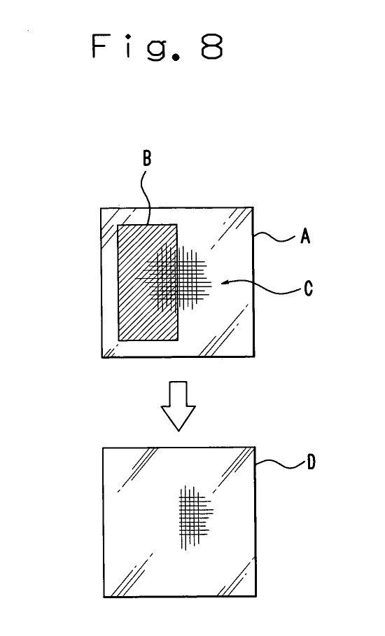

FIG. 8 is an illustration showing an experimental result as to how much an occurrence of fine powder is different in a case of cutting a color developed area and in a case of cutting a non-color developed area of the thermal recording medium 2 and 3. An amount of fine powder is determined by adhesion strength between the base sheet and the thermal color developing layer. An experiment of the adhesiveness of the thermal color developing layer was done by a cross cutting method specified in JIS (Japanese Industrial Standard). As an experiment sample, a thermal recording medium A that is 100 mm in width, on which a color developed area that is 20 mm in width is formed by a printing apparatus in a standard printing condition, is used. A cross cut portion C having 10 slits formed in each of two direction of so as to crisscross are formed by a cross cutting jig (Cotec Corporation: cross cut guide 1.0) on the sample. The cross cut portion is formed to cover both the color developed area and the non-color developed area. The color developed area is formed by a hot stamp by heating for 10 seconds at 130 degree Celsius. An adhesive tape D is adhered to the cross cut portion. Then the adhesive tape D is peered from one end at a 90 degrees angle, and the status of adhesion of the thermal color developing layer on the adhesive tape D is examined. A transparent adhesive tape ┌BH-18┘ manufactured by Scotch Corporation is preferred as the adhesive tape.

Consequently, it is confirmed that a white thermal color developing layer adheres on the adhesive tape D from the non-color developed area. On the other hand, there is no adhesion of thermal color developing layer on the adhesive tape D from the color developed area. As seen in this experiment, superior adhesiveness can be confirmed between the base sheet and the thermal color developing layer in the color developed area B, compared to in the non-color developed area, and the occurrence of fine powder can be inhibited.

The first embodiment of the present invention refers to the process of developing a color on the cutting portion before cutting off the thermal recording medium (or thermal paper). Hereinafter, the second embodiment of the present invention will refer to a process of developing a color on the cut portion after cutting off the thermal recording medium (or thermal paper).

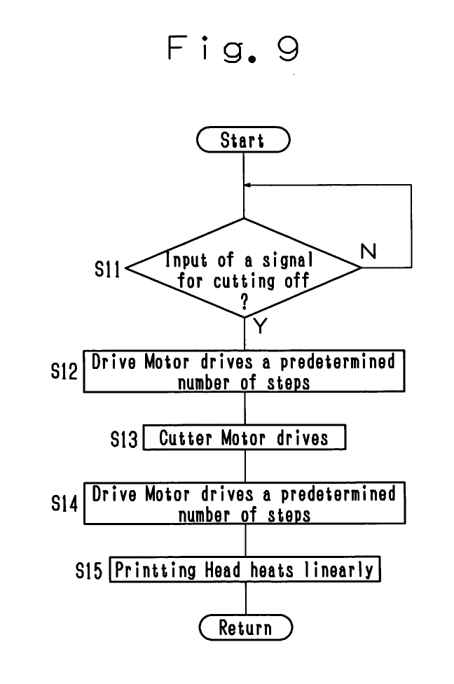

FIG. 9 is a flow chart showing steps of printing on the thermal recording medium 3, cutting off the thermal recording printing medium from the thermal recording medium 3, and developing a color on the cut portion.

Steps of developing a color on the cut portion of the thermal color developing layer after the thermal recording medium 3 is cut by the apparatus 1 will be explained with reference to the flow chart of FIG. 9.

In the apparatus 1, printing is executed by putting the heated printing head 15 toward the unrolled thermal recording medium 3, and then it is judged whether a signal for cutting off the thermal recording medium 3 is input or not during the printing operation (step S11). The signal for cutting the thermal recording medium 3 is input by the cutter button 8 being pressed.

When the signal for cutting the thermal recording medium 3 is input (Y of step S11), the drive motor 27 drives a predetermined number of steps (step S12) to convey an area of the thermal recording medium 3 where color is to be developed to a cutting position by the cutter 18.

After the drive motor 27 drives a predetermined number of steps at step 3, the cutter motor 28 drives (step S13) to execute cutting the area of the thermal recording medium 3 where color is to be developed.

After being cut by the cutter 18, the area where color is to be developed is driven back a predetermined number of steps in the reverse direction of step S12 by the drive motor 27 to the position of the printing head 15.

The printing head 15 heats an end portion of the cut off portion of the thermal recording medium 3 in the across-the-width direction (step S15), and the end portion develops a color in the across-the-width direction. A technique for developing a color on an end of the thermal recording medium 3, which is cut off by the cutter 18, in the across-the-width direction is thus executed.

An experiment was done as to how much an occurrence of fine powder is different in a case of a color developing area and in a case of a non-color developing area, which is similar experiment to the first embodiment of the present invention. A similar result was obtained but since a thermal color developing layer of a cutting portion of the thermal recording medium 3 is cut off without developing a color, the fine powder occurs when the cutting is executed. Thus, the second embodiment is to some extent effective to inhibit to the occurrence of fine powder from the cutting portion of the thermal recording medium 3 (thermal paper 2a); however, the first embodiment is more effective.

Although the second embodiment refers to the method of developing a color on an end of the cutting portion by the printing head 15 in a process of manufacturing a thermal paper, the thermal color developing layer can develop a color by a nichrome wire in non-contact manner. This is also effective to increase adhesiveness of the base sheet and the thermal color developing layer so that the occurrence of fine powder can be inhibited. As a secondary effect as referred to above, a position of each color can be confirmed in a case of a thermal color developing layer which develops various colors formed on the thermal recording medium.

Obviously, numerous modifications and variations of the present invention are possible in light of the above teachings. It is therefore to be understood that within the scope of the appended claims, the invention may be practiced otherwise than as specifically described herein.

What is claimed is:

1. A method for manufacturing a thermal paper from a thermal recording medium having a thermal color developing layer on a recording surface thereof, said method comprising:
developing at least one color on one portion of the thermal color developing layer; and
cutting off a portion of the thermal recording medium at said one portion.

2. The method for manufacturing the thermal paper according to claim 1, wherein developing the color on the one portion is executed before cutting off the thermal paper at the one portion.

3. The method for manufacturing the thermal paper according to claim 1, wherein the thermal color developing layer comprises multiple areas which develop various colors.

4. The method for manufacturing the thermal paper according to claim 2, wherein the thermal color developing layer comprises multiple areas which develop various colors.

5. A thermal paper formed from a thermal recording medium, said thermal paper comprising:
a base sheet including a cutting plane at an edge thereof, and a recording surface on one surface thereof;
a thermal color developing layer which is laminated on the recording surface and which includes a cutting plane that forms a continuous plane with the cutting plane of the base sheet; and
a color developing area which is formed by heating the thermal color developing layer in an area that includes the cutting plane of the thermal color developing layer.

6. The thermal paper according to claim 5, wherein the thermal color developing layer comprises multiple areas which develop various colors.

7. An apparatus for manufacturing a thermal paper from a thermal recording medium having a thermal color developing layer on a recording surface thereof, said apparatus comprising:
means for developing a color on one portion of the thermal color developing layer; and
means for cutting off a portion of the thermal recording medium at said one portion.

8. The apparatus for manufacturing the thermal recoding printing material according to claim 7, wherein the thermal color developing layer comprises multiple areas which develop various colors.
